(19) United States
(12) Patent Application Publication
(10) Pub. No.: US 2023/0031343 A1
(43) Pub. Date: Feb. 2, 2023

(54) METHOD AND SYSTEM FOR ESTIMATING A QUANTITY REPRESENTATIVE OF SOUND ENERGY

(71) Applicant: FONDATION B-COM, Cesson-Sévigné (FR)

(72) Inventor: Nicolas EPAIN, RENNES (FR)

(21) Appl. No.: 17/789,440

(22) PCT Filed: Dec. 18, 2020
(86) PCT No.: PCT/EP2020/087212

§ 371 Date: Jun. 27, 2022

(30) Foreign Application Priority Data
Dec. 27, 2019 (FR) FR1915670

(51) Int. Cl. G01S 5/20

(52) U.S. Cl. CPC G01S 5/20

(57) ABSTRACT

A method and associated system for estimating a quantity representative of the sound energy at at least one point of a three-dimensional space where a plurality of antennas are situated, each including at least K acoustic sensors, K being higher than or equal to 2, includes for each antenna of the plurality of antennas, production of a plurality of signals representative of the sound field at the antenna in question, for each antenna of the plurality of antennas, determination of a raw value of the quantity at the point based on at least K+1 elements of a matrix that are based respectively on pairwise combinations of representative signals produced by the antenna in question, and determination of an estimated value of the quantity at the point by combining the raw values of the quantity at the point determined respectively for the various antennas of the plurality of antennas.

### TECHNICAL FIELD OF THE INVENTION

The present invention relates to the technical field of acoustics and acoustic signal processing.

It is in particular aimed at a method and a system for estimating a quantity representative of sound energy.

### Etat de la Technique

It has already been contemplated to estimate a quantity representative of sound energy at at least one point of a three-dimensional space by means of a plurality of arrays each comprising several acoustic sensors and located in this three-dimensional space.

The article “Localization of Multiple Acoustic Sources with a Distributed Array of Unsynchronized First-Order Ambisonics Microphones”, by C. Shörkhuber, P. Hack, M. Zaunschirm, F. Zotter and A. Sontacchi, in Proceedings of the 6^{th} Congress of the Alps-Adria Acoustics Association, October 2014, Graz, Austria proposes a solution in which, under the hypothesis of temporal and spectral disjointness, a difference-of-arrival histogram covering a set of directions around the array is built for each array, then a spatially discretized probability function is calculated by combining the histograms obtained for the various arrays.

### DISCLOSURE OF THE INVENTION

In this context, the present invention proposes a method for estimating a quantity representative of the sound energy at at least one point of a three-dimensional space where a plurality of arrays are located, each comprising at least K acoustic sensors, K being higher than or equal to 2, comprising the following steps:
for each array of the plurality of arrays, producing a plurality of signals representative of the sound field at the array in question;
for each array of the plurality of arrays, determining a raw value of said quantity at said point based on at least K+1 elements of a matrix that are based respectively on pairwise combinations of representative signals produced by the array in question;
determining an estimated value of said quantity at said point by combining the raw values of said quantity at said point, determined for the various arrays of the plurality of arrays respectively.

The use of arrays each comprising at least 2 acoustic sensors (and preferably at least 4 acoustic sensors) allows a fine analysis of the sound field at the array. The various signals resulting from this analysis allow generating a matrix that renders accurately the sound field present at the array. The sound field analysis is thus both rich and made in a compact way, so that it is possible to map correctly the sound field at the array.

In the case where 2nd-order ambisonic signals are used, for example, the number K of acoustic sensors per array is higher than or equal to 9. In the case where 3rd-order ambisonic signals are used, the number K of acoustic sensors per array is higher than 16.

The step of determining a raw value for a given array may comprise the following sub-steps:
determining, based on said matrix, a directional value of the quantity representative of the sound energy received at the given array from a direction connecting said point and the given array;
determining the raw value for the given array based on the directional value determined.

In order to cover a set of directions about each array, the estimation method may comprise, for each array of the plurality of arrays, a step of determining, based on said matrix, a plurality of directional values of the quantity representative of the sound energy received at the array in question, from a plurality of directions respectively.

Moreover, it may be provided, for at least one array of the plurality of arrays, a step of refining the directional values by means of a beamforming technique.

The estimation method may further comprise, in this case, for each array of the plurality of arrays, a step of determining raw values of said quantity at a plurality of points based on the directional values determined for the array in question.

The method may then comprise, for each point of said plurality of points, a step of determining an estimated value of said quantity at the point in question by combining the raw values determined for the various arrays of the plurality of arrays at the point in question.

A mapping of the quantity representative of the sound energy is thus carried out.

The method may further comprise a step of refining the raw values by means of a beamforming technique using the values estimated for the various points of the plurality of points.

In practice, the estimated value of said quantity may be determined by applying to the raw values a multi-variable function whose image is zero for any antecedent comprising at least one zero variable, which makes it possible to determine relatively simply the estimated value of said quantity on the basis of the raw values.

The estimated value of said quantity may for example be equal to the inverse of the sum of the inverses of the raw values.

According to another conceivable possibility, the estimated value of said quantity may be equal to the M-th root of the product of the raw values, where M is the number of arrays of the plurality of arrays.

The pairwise combination of representative signals are for example each an estimation of the mathematical expectation of the product of the representative signals in question.

The above-mentioned representative signals may be produced by processing measurements respectively acquired by the acoustic sensors of the array in question.

The above-mentioned quantity is for example the acoustic power. As an alternative, it could be the acoustic pressure (defined on the basis of the square root of the acoustic power).

The present invention also relates to a system for estimating a quantity representative of the sound energy at at least one point of a three-dimensional space comprising:
a plurality of arrays each comprising at least K acoustic sensors and each adapted to produce a plurality of signals representative of the sound field at the array in question and to determine a raw value of said quantity at said point on the basis of at least K+1 elements of a matrix that are based respectively on pairwise combinations of representative signals produced by the array in question, K being higher than or equal to 2; and
a processor adapted to determine an estimated value of said quantity at said point by combining the raw values of said quantity at said point, determined for the various arrays of the plurality of arrays respectively.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limiting embodiments of the invention, and wherein:

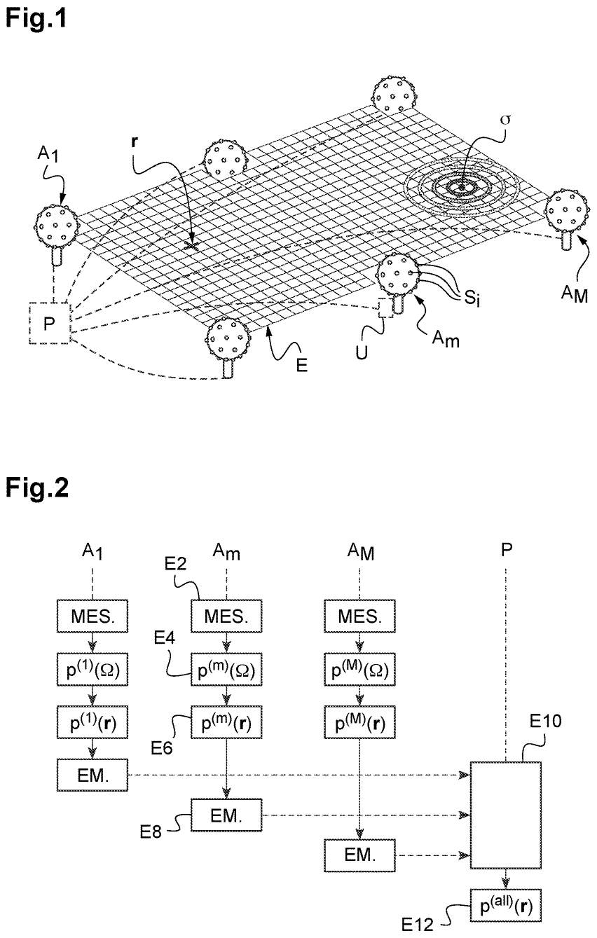

FIG. 1 schematically shows a system comprising a processor and a plurality of arrays;

FIG. 2 is a flowchart showing the main steps of a method for estimating a quantity representative of the sound energy according to the invention;

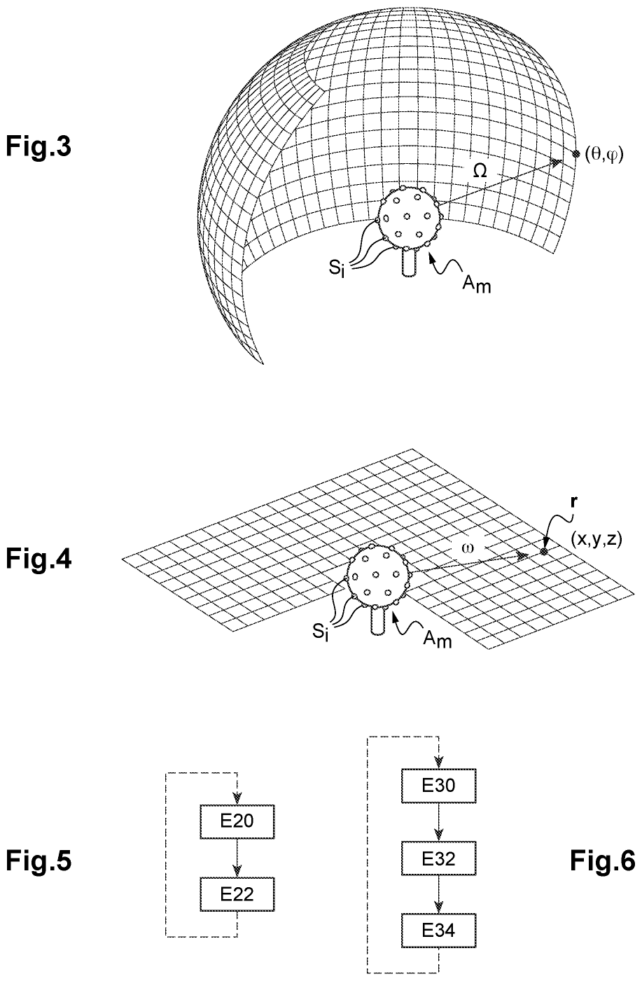

FIG. 3 schematically shows a particular direction in space relative to an array of the plurality of arrays of FIG. 1;

FIG. 4 schematically shows a meshing of the space about the array of FIG. 3;

FIG. 5 is a flowchart showing a method for refining directional values by means of a beamforming technique; and

FIG. 6 is a flowchart showing a method for refining raw and estimated values by means of a beamforming technique.

The system shown in FIG. 1 comprises a processor P and a plurality of arrays (here M arrays) A₁, Aₘ, A_{M}.

As schematically shown in FIG. 1, the various arrays A₁, Aₘ, A_{M} are respectively located at various points of a three-dimensional space E.

Each array Aₘ comprises several acoustic sensors Sᵢ each capable of making a measurement of a sound field present at the acoustic sensor Sᵢ in question. In FIG. 1 is schematically shown an acoustic wave transmitted by a sound source G, but the invention applies regardless the number of sound sources.

In the example described herein, each array Aₘ comprises exactly K acoustic sensors (K being higher than or equal to 2, preferably K being higher than or equal to 4), for example 35 acoustic sensors. As an alternative, however, certain acoustic arrays could comprise more than K acoustic sensors.

Each array Aₘ also comprises a processing unit U adapted to process the signals measured by the acoustic sensors Sᵢ of the array in question, as explained hereinafter.

Each array Aₘ can moreover communicate with processor P (for example by means of a wireless link or, as an alternative, a wire link) in order to allow data exchanges between the processing unit U of this array Aₘ and processor P.

FIG. 2 shows the main steps of a method for estimating a quantity representative of the sound energy according to the invention. In the example described herein, the quantity used to represent the sound energy is the acoustic power.

Steps E2 to E8 that will now be described are implemented in each of the arrays A₁, Aₘ, A_{M}. However, for the sake of brevity, a single array reference is given below: Aₘ.

The method starts by a step E2 of acquiring respective measurements by the K acoustic sensors Sᵢ of each array Aₘ of the plurality of arrays.

In the example described hereinafter, step E2 further comprises a processing (by the processing unit U of each array Aₘ) of the measurements acquired by the K acoustic sensors Sᵢ of the array Aₘ in question in order to produce signals sₖ(t) representative of the sound field at the array Aₘ in question. According to the representation used, these signals sₖ(t) may be complex signals (i.e. represented as complex number in order to define a module, or amplitude, and a phase) or real signals.

These signals sₖ(t) are for example L-order ambisonic signals. The L-order ambisonic representation indeed allows representing the sound field at the array Aₘ in question by means of N signals sₖ(t) with N=(L+1)². Generally, the number K of acoustic sensors is higher than or equal to the number N of signals sₖ(t) produced.

The method then continues, at each array Aₘ (and by means of the processing unit U of the array Aₘ in question), by a step E4 of determining directional values p^{(m)}(Ω) of the acoustic power received at the array Aₘ from a plurality of directions Ω.

As schematically shown in FIG. 3, processing unit U determines for example the directional value p^{(m)}(Ω) for a set of directions Ω forming an angular meshing about the array Aₘ in question, each direction Ω corresponding to particular spherical angular coordinates (θ, φ), where θ is the elevation (between 0 and π) and φ is the azimuth (between 0 and 2π). For example, in practice, a meshing (such as a Lebedev meshing) is used, which comprises a number of directions between a few tens and several thousands (i.e. in practice between 50 and 5,000).

For each direction Ω (and at each time for which the estimation is made), each processing unit U determines for that purpose the elements of a covariance matrix Cₛₛ in which:
each diagonal element is an estimation of the mathematical expectation of the square of the module of one of the signals sₖ(t) representative of the sound field (the covariance matrix Cₛₛ here comprises N diagonal elements);
each non-diagonal element is an estimation of the mathematical expectation of the product of one sᵢ(t) of the signals representative of the sound field by the conjugate of another sᵢ(t) of the signals representative of the sound field (the covariance matrix Cₛₛ here comprises N(N−1) non-diagonal elements).

The covariance matrix Cₛₛ provides a set of statistical information about the spatial properties of the sound field, in particular about the position of the sound sources and the more or less strong correlation of the signals transmitted by them. From this point of view, each element of the matrix enriches the information and thus allows refining the analysis performed.

In the case where ambisonic signals sₖ(t) with real values are used as described here, the covariance matrix Cₛₛ is written:

$${C}_{ss} = [ \begin{matrix}E \{ {[ {s}_{1} ( t ) ]}^{2} \} & … & E \{ {s}_{1} ( t ) \cdot {s}_{N} ( t ) \} \\ ⋮ & ⋱ & ⋮ \\ E \{ {s}_{N} ( t ) \cdot {s}_{1} ( t ) \} & … & E \{ {[ {s}_{N} ( t ) ]}^{2} \}\end{matrix} ] ,$$

where E is a function estimating the mathematical expectation of the signal in question.

In practice, the function E may be an indicator of central tendency of the signal in question over a predetermined number of samples of this signal (the samples used in the calculation of the central tendency indicator being generally the last samples produced). The function E is for example the (sliding) average of the signal over this predetermined number of (last) samples.

The directional value p^{(m)}(Ω) of the acoustic power received from a direction Ω is then written:

$${p}^{( m )} ( Ω ) = \frac{1}{{a}^{H} ( Ω ) {C}_{ss}^{- 1} a ( Ω )} ,$$

where (.)^{H} is the transpose-conjugate operator and a(Ω) is a steering vector of the direction Ω defined as follows in the case of ambisonic signals sₖ(t):

$$a ( Ω ) = ( \begin{matrix}{Y}_{0}^{0} ( θ , φ ) \\ {Y}_{l}^{q} ( θ , φ ) \\ {Y}_{L}^{L} ( θ , φ )\end{matrix} ) ,$$

where Yₗ^{q} is the spherical harmonic function of real value of order l and degree q and the variables θ and φ represent the direction Ω in spherical coordinates. (The number of spherical harmonic functions of order lower or equal to L being equal to (L+1)², the vector a(Ω) is of dimension N=(L+1)² and the above-mentioned covariance matrix Cₛₛ of size N×N.)

The directional values p^{(m)}(Ω) obtained for a given array Aₘ can potentially be refined by means of a beamforming technique, as described hereinafter with reference to FIG. 5.

The processing unit U of each array Aₘ then performs a step E6 of determining raw values p^{(m)}(r) of the acoustic power at a plurality of points of the three-dimensional space E, the position of a point being given by a coordinate vector r.

The points where the raw values p^{(m)}(r) of acoustic power are determined are for example predefined and are the same for all the arrays Aₘ. These points form for example a meshing of the area of interest of the three-dimensional space (area that thus comprises all the arrays Aₘ).

A portion of this meshing around a particular array Aₘ is schematically shown in FIG. 4. (For the sake of clarity, the meshing shown in FIG. 4 is two-dimensional, but this meshing may in practice be three-dimensional.) In practice, for example, a number of points is used, which is included (depending on the size of the meshing) between a few tens and tens of thousands (i.e. in practice between 50 and 50,000). As an alternative, it could be possible to consider only points located in a given plane (as shown in FIG. 4).

For each point indicated by its coordinates r (comprising for example three coordinates (x,y,z) as shown in FIG. 4), the raw value p^{(m)}(r) of acoustic power at that point is determined based on the directional value p^{(m)}(w) determined at step E4 for the direction w connecting this point and the array Aₘ in question, for example by interpolation of the directional values p^{(m)}(ω) determined at step E4. In the case described herein, in which the possible directions vary in azimuth and elevation, it may be for example an interpolation by spherical spline or using spherical harmonic functions. In the case where the meshing is two-dimensional and the considered directions therefore extend in the plane of the meshing, a linear or quadratic interpolation can be used.

For each array Aₘ, the raw values p^{(m)}(r) determined by this array Aₘ (precisely by the processing unit U of this array Aₘ) are then transmitted at step E8 to processor P.

Processor P thus receives at step E10 all the raw values p^{(m)}(r) determined by all the arrays Aₘ of the plurality of arrays.

Processor P can hence determine, at step E12, for all the points considered, an so estimated value p^{(all)}(r) of the acoustic power at the point in question by combining the raw values p^{(m)}(r) for this point received from the various arrays Aₘ.

The estimated value p^{(all)}(r) for a given point (of coordinates r) is for example determined by applying, to the raw values p^{(m)}(r) for this given point, a multi-variable function f (the number of variables x₁, x₂, . . . , x_{M} being equal to the number of arrays) and whose image f(x₁, x₂, . . . , x_{M}) is equal to zero for any antecedent (x₁, x₂, . . . , x_{M}) comprising at least one zero variable xᵢ.

In other words, the function f verifies: f(x₁, x₂, . . . , x_{M})=0 if (at least) one index i exists between 1 and M such that xᵢ=0.

The estimated value p^{(all)}(r) for a given point is then equal to:

p^{(all)}(r)=f(p⁽¹⁾(r),p⁽²⁾(r), . . . ,p^{(M)}(r)).

The use of such a function f is interesting in that it allows obtaining an estimated value p^{(all)}(r) that is zero (or very low in practice) whenever one of the raw values p^{(m)}(r) is zero (or very low in practice), which tends to reduce the occurrence of noise in the estimation process.

In practice, the estimated value p^{(all)}(r) for a given point may be determined as follows:

$${p}^{( all )} ( r ) = \frac{1}{{{Σ}_{m = 1}^{M} [ {p}^{( m )} ( r ) ]}^{- 1}} .$$

In other words, in this case, the estimated value p^{(all)}(r) is equal to the inverse of the sum of the inverses of the M raw values p^{(m)}(r).

This solution, based on the hypothesis of absence of interaction between the various arrays, is simple to implement and gives good results in practice.

It can be noticed that this possible embodiment corresponds to the case of a function f as proposed hereinabove due to the fact that the above expression of p^{(all)}(r) may also be written:

$${p}^{( all )} ( r ) = \frac{{p}^{( 1 )} ( r ) \cdot {p}^{( 2 )} ( r ) … \cdot {p}^{( M )} ( r )}{{p}^{( 2 )} ( r ) \cdot {p}^{( 3 )} ( r ) … \cdot {p}^{( M )} ( r ) + … + {p}^{( 1 )} ( r ) \cdot {p}^{( 2 )} ( r ) … \cdot {p}^{( M - 1 )} ( r )} .$$

According to a conceivable alternative, the processor determines as follows the estimated value p^{(all)}(r) for a given point:

p^{(all)}(r)=(Πₘ₌₁^{M}p^{(m)}(r))^{1/M}.

In other words, in this case, the estimated value p^{(all)}(r) is equal to the M-th root of the product of the raw values (p^{(m)}(r)).

Once the estimated values p^{(all)}(r) determined for the plurality of considered points, it is possible to refine the corresponding raw vales p^{(m)}(r) associated with the various arrays Aₘ, and thus the estimated values p^{(all)}(r) themselves, by means of a beamforming technique, as described hereinafter with reference to FIG. 6.

FIG. 5 shows a method for refining the directional values p^{(m)}(Ω) by means of a beamforming technique. The implementation of this refining method is described for a particular array Aₘ, but the method may be implemented (for example, by the processing unit U of the array in question) for several of said arrays (or even for all said arrays).

As indicated hereinabove, this refining method may take place when a set of D directional values p^{(m)}(Ωᵢ) has been determined (as indicated hereinabove in relation with step E4) for D directions Ω₁, . . . , Ω_{D}, respectively.

This refining method starts by a step E20 of determining a matrix V^{(m)} defined as followed:

V^{(m)}=W^{(m)}A^{H}(AW^{(m)}A^{H}+R)⁻¹, with

A a matrix obtained by concatenating the pointing vectors a(Ωᵢ) defined as hereinabove, each for a direction Ωᵢ, and associated with the D directions Ωᵢ, . . . , Ω_{D}, respectively,

W^{(m)} the diagonal matrix comprising (in diagonal) the directional values p^{(m)}(Ωᵢ) previously determined for the D directions Ω₁, . . . , Ω_{D},

R a regularization matrix that allows taking account of the presence of diffuse noise in the measured signals.

Reference may be made to the book “Geophysical Data Analysis: Diverse Inverse Theory, 4th Edition”, Academic Press, 2008, p. 62 for more details about this technique indicated as the solution to the “weighted damped least-square problem”.

The refining method continues with a step E22 in which the processing unit U in question determines a refined version of the matrix W^{(m)} (and therefore of the directional values p^{(m)}(Ωᵢ) present on the diagonal of this matrix) as follows:

Z^{(m)}=V^{(m)}Cₛₛ^{(m)}V^{(m)H}

W^{(m)}=diag(Z^{(m)})

where Cₛₛ^{(m)} is the covariance matrix determined (as indicated hereinabove at step E4) for the array Aₘ in question (and at the moment in question),

where diag is the operator that, with matrix Z^{(m)}, associates the diagonal matrix W^{(m)}, whose diagonal elements are identical to those of matrix Z^{(m)} (and whose other elements are zero).

The new directional values p^{(m)}(Ωᵢ) present on the diagonal of the so-obtained matrix W^{(m)} may be used for the following of the method.

Steps E20 and E22 may in practice be repeated several times to further refine the directional values p^{(m)}(Ωᵢ).

FIG. 6 shows a method for refining the directional values p^{(m)}(r) and the estimated values p^{(all)}(r) by means of a beamforming technique.

This refining method starts with a step E30 in which processor P determines, for each array Aₘ, a matrix V^{(m)} as follows:

V^{(m)}=W^{(all)}A^{(m)H}(A^{(m)}W^{(all)}A^{(m)H}+R)⁻¹, with

A^{(m)} a matrix obtained by concatenating the pointing vectors a(ωᵢ) defined, for a set of T points (of the area of interest) indicated by vectors r₁, r₂, . . . , r_{T}, by the direction Wi connecting the array Aₘ to the point rᵢ in question (the pointing vector associated with a particular direction being defined hereinabove),

W^{(m)} the diagonal matrix comprising (in diagonal) the estimated values p^{(all)}(rᵢ) previously determined for the T points of coordinates r₁, r₂, . . . , r_{T},

R a regularization matrix that allows taking account of the presence of diffuse noise in the measured signals and of sound sources present out of the area of interest.

This solution is of the same type as that proposed hereinabove for refining the directional values and reference can therefore also be made to the above-mentioned book for more details on this subject.

The refining method continues with a step E32 of determining, for each array Aₘ, refined raw values p^{(m)}(rᵢ). For that purpose, processor P determines the matrix V^{(m)}Cₛₛ^{(m)}V^{(m)H}, the refined raw values p^{(m)}(r₁), p^{(m)}(r₂), . . . , p^{(m)}(r_{T}) then being the diagonal elements of this matrix V^{(m)}Cₛₛ^{(m)}V^{(m)H} (matrix Cₛₛ^{(m)} being as hereinabove the covariance matrix determined at step E4 for the array Aₘ in question).

Processor P can then obtain at step E34, for each point rᵢ of the plurality of T points of coordinates r₁, r₂, . . . , r_{T}, a refined estimated value p^{(all)}(rᵢ) by combining the M refined raw values p^{(m)}(rᵢ) obtained for this point rᵢ for the various arrays Aₘ, respectively, for example by the combination method described hereinabove at step E12:

p^{(all)}(rᵢ)=f(p⁽¹⁾(rᵢ),p⁽²⁾(rᵢ), . . . ,p^{(M)}(rᵢ)).

Steps E30 to E34 may in practice be repeated several times to further refine the raw values p^{(m)}(rᵢ) and the estimated values p^{(all)}(rᵢ).

1. A method for estimating a quantity representative of the sound energy at at least one point of a three-dimensional space where a plurality of arrays are located, each of the plurality of arrays including at least K acoustic sensors, K being greater than or equal to 2, the method comprising:
for each array of the plurality of arrays, producing a plurality of signals representative of the sound field at the respective array;
for each array of the plurality of arrays, determining a raw value of said quantity at said point based on at least K+1 elements of a matrix that are based respectively on pairwise combinations of representative signals produced by the respective array; and
determining an estimated value of said quantity at said point by combining the respective raw values of said quantity at said point, determined for the respective arrays of the plurality of arrays.

2. The estimation method according to claim 1, wherein the determining the raw value for the respective array comprises:
determining, based on said matrix, a directional value of the quantity representative of the sound energy received at the respective array from a direction connecting said point and the respective array, and
determining the raw value for the respective array based on the determined directional value determined.

3. The estimation method according to claim 1, further comprising, for each array of the plurality of arrays, determining, based on said matrix, a plurality of directional values of the quantity representative of the sound energy received at the respective array, from a plurality of directions respectively.

4. The method according to claim 3, further comprising, for at least one array of the plurality of arrays, refining the directional values by a beamforming technique.

5. The method according to claim 3, further comprising, for each array of the plurality of arrays, determining raw values of said quantity at a plurality of points based on the determined directional values determined for the respective array.

6. The estimation method according to claim 5, further comprising, for each point of said plurality of points, determining an estimated value of said quantity at the respective point by combining the respective raw values determined for the respective arrays of the plurality of arrays at the respective point.

7. The method according to claim 6, further comprising refining the raw values by a beamforming technique using the respective estimated values estimated for the respective points of the plurality of points.

8. The estimation method according to claim 1, wherein the estimated value of said quantity is determined by applying to the raw values, a multi-variable function whose having an image that is zero for any antecedent comprising at least one zero variable.

9. The estimation method according to claim 8, wherein the estimated value of said quantity is equal to the inverse of a sum of the inverses of the raw values.

10. The estimation method according to claim 8, wherein the estimated value of said quantity is equal to the M-th root of the product of the raw values, where M is the number of arrays of the plurality of arrays.

11. The estimation method according to claim 1, wherein each of said pairwise combinations of representative signals are an estimation of the mathematical expectation of the product of the respective representative signals.

12. The estimation method according to claim 1, wherein said representative signals are produced by processing measurements respectively acquired by the acoustic sensors of the respective array.

13. The estimation method according to claim 1, wherein said quantity is an acoustic power.

14. A system for estimating a quantity representative of the sound energy at at least one point of a three-dimensional space, the system comprising:
a plurality of arrays, each of the arrays comprising at least K acoustic sensors and configured to produce a plurality of signals representative of the sound field at the respective array and to determine a raw value of said quantity at said point based on at least K+1 elements of a matrix that are based respectively on pairwise combinations of representative signals produced by the respective array, K being greater than or equal to 2; and
a processor configured to determine an estimated value of said quantity at said point by combining the raw values of said quantity at said point, determined for the respective arrays of the plurality of arrays.

15. The estimation method according to claim 2, further comprising, for each array of the plurality of arrays, determining, based on said matrix, a plurality of directional values of the quantity representative of the sound energy received at the respective array, from a plurality of directions respectively.

16. The estimation method according to claim 2, wherein the estimated value of said quantity is determined by applying, to the raw values, a multi-variable function having an image that is zero for any antecedent comprising at least one zero variable.

17. The estimation method according to claim 2, wherein each of said pairwise combinations of representative signals are an estimation of the mathematical expectation of the product of the respective representative signals.

18. The estimation method according to claim 2, wherein said representative signals are produced by processing measurements respectively acquired by the acoustic sensors of the respective array.

19. The estimation method according to claim 2, wherein said quantity is an acoustic power.
